(19) United States
(12) Patent Application Publication
(10) Pub. No.: US 2026/0313591 A1
(43) Pub. Date: Oct. 8, 2026

(54) SIDELINK POSITIONING FOR MULTIPLE TARGET USER EQUIPMENT

(71) Applicant: Apple Inc., Cupertino, CA (US)

(72) Inventors: Alexander SIROTKIN, Hod Hasharon (IL); Fangli XU, Beijing (CN); Haijing HU, Los Gatos, CA (US); Naveen Kumar R. PALLE VENKATA, San Diego, CA (US); Oghenekome OTERI, San Diego, CA (US); Peng CHENG, Beijing (CN); Ping-Heng KUO, London (GB); Ralf ROSSBACH, Munich (DE); Yuqin CHEN, Beijing (CN); Zhibin WU, Los Altos, CA (US)

(21) Appl. No.: 19/482,144

(22) PCT Filed: May 11, 2023
(86) PCT No.: PCT/CN2023/093596

§ 371 Date: Nov. 6, 2025

(51) Int. Cl. H04W 64/00; G01S 13/76; H04W 92/18

(52) U.S. Cl. CPC H04W 64/00; G01S 13/765; H04W 92/18

(57) ABSTRACT

Methods, systems, apparatuses, and computer programs for sidelink (SL) positioning of target UEs in a single positioning session are disclosed. In one aspect, operations are performed by a reference UE and can include transmitting a first SL positioning reference signal (SL-PRS) to a first target UE and a second target UE; receiving, in response to transmitting the first SL-PRS, a second SL-PRS and a third SL-PRS from a first target UE and a second target UE, respectively; and obtaining (i) first time of flight (ToF) information indicative of a first distance between the reference UE and the first target UE based on the second SL-PRS, and (ii) second ToF information indicative of a second distance between the reference UE and the second target UE based on the third SL-PRS.

### BACKGROUND

Wireless communication networks, such as fourth generation (4G), fifth generation (5G), etc., provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time-division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

Sidelink (SL) positioning is a technique used in wireless communication networks, which allows devices (e.g., user equipment) to exchange location information directly with each other. This direct device-to-device communication is also known as device-to-device (D2D) communication. SL positioning enables various use cases, such as vehicle-to-vehicle communication, proximity services, indoor positioning, etc.

### SUMMARY

According to one innovative aspect of the present disclosure, one or more processors of a reference user equipment (UE) configured to perform operations for sidelink (SL) positioning of target UEs in a single positioning session are disclosed. In one aspect, the operations can include transmitting, by the reference UE, a first SL positioning reference signal (SL-PRS) to a first target UE and a second target UE; receiving, by the reference UE and in response to transmitting the first SL-PRS, a second SL-PRS and a third SL-PRS from a first target UE and a second target UE, respectively; and obtaining, by the reference UE, (i) first time of flight (ToF) information indicative of a first distance between the reference UE and the first target UE based on the second SL-PRS, and (ii) second ToF information indicative of a second distance between the reference UE and the second target UE based on the third SL-PRS.

Other aspects include methods, apparatuses, systems, and computer programs for performing the aforementioned operations.

The innovative operations can include other optional features. For example, in some implementations, the operations can further include transmitting, by the reference UE, a fourth SL-PRS to the first target UE and the second target UE in response to receiving the second SL-PRS and the third SL-PRS. The first target UE and the second target UE use the fourth SL-PRS to calculate respective ToF information indicative of a distance between the respective target UE and the reference UE.

In some implementations, the operations can further include obtaining, by the reference UE, the first distance based on the first ToF information and the second distance based on the second ToF information.

In some implementations, the operations can further include receiving, by the reference UE and from a base station, a first SL-PRS configuration of the second SL-PRS and a second SL-PRS configuration of the third SL-PRS, via radio resource control (RRC) signaling in the single positioning session.

In some implementations, the operations can further include receiving, by the reference UE and from a location measurement function (LMF), a first SL-PRS configuration of the second SL-PRS and a second SL-PRS configuration of the third SL-PRS, via LTE Positioning Protocol (LPP) signaling in the single positioning session.

In some implementations, the operations can further include receiving, by the reference UE and from the first target UE, a first SL-PRS configuration of the second SL-PRS and a second SL-PRS configuration of the third SL-PRS, via a Sidelink Positioning Protocol (SLPP) in the single positioning session.

In some implementations, at least one of the first SL-PRS configuration or the second SL-PRS configuration includes a session identifier for identifying the single positioning session.

In some implementations, the operations can further include receiving, by the reference UE and from a location measurement function (LMF) via LTE Positioning Protocol (LPP), a first message requesting a first distance between the reference UE and the first target UE and a second distance between the reference UE and the second target UE, wherein the first message includes an identifier of the first target UE and an identifier of the second target UE; and transmitting, by the reference UE and to the LMF, a second message including either: (i) the first ToF information and the second ToF information, or (ii) the first distance and the second distance.

In some implementations, the second message further includes at least one of Sidelink Positioning Reference Signal Received Power (RSRP), Sidelink Positioning Reference Signal Received Power per resource element (SL-PRS RSRPP), or Sidelink Angle of Arrival (SL-AoA).

In some implementations, the first ToF information includes a first time period between transmitting the first SL-PRS and receiving the second SL-PRS, and the second ToF information includes a second time period between transmitting the first SL-PRS and receiving the third SL-PRS.

In some implementations, the first ToF information further includes a third time period between receiving the first SL-PRS by the first target UE and transmitting the second SL-PRS by the first target UE, and the second ToF information further includes a fourth time period between receiving the first SL-PRS by the second target UE and transmitting the third SL-PRS by the second target UE.

In some implementations, the third time period or the fourth time period is a predetermined value (“hardcoded in the specifications”) or preconfigured by a base station.

In some implementations, at least one of the first message or the second message includes a session identifier for identifying the single positioning session.

In some implementations, the operations can further include receiving, by the reference UE and from the first target UE and the second target UE, via Sidelink Positioning Protocol (SLPP), a first message requesting a first distance between the reference UE and the first target UE and a second distance between the reference UE and the second target UE, wherein the first message includes an identifier of the first target UE and an identifier of the second target UE; and transmitting, by the reference UE and to the first target UE and the second target UE, a second message including either: (i) the first ToF information and the second ToF information, or (ii) the first distance and the second distance.

In some implementations, the second message further includes at least one of Sidelink Positioning Reference Signal Received Power (RSRP), Sidelink Positioning Reference Signal Received Power per resource element (SL-PRS RSRPP), or Sidelink Angle of Arrival (SL-AoA) for the first target UE or the second target UE.

In some implementations, the first ToF information includes a first time period between transmitting the first SL-PRS and receiving the second SL-PRS, and the second ToF information includes a second time period between transmitting the first SL-PRS and receiving the third SL-PRS.

In some implementations, the first ToF information further includes a third time period between receiving the first SL-PRS by the first target UE and transmitting the second SL-PRS by the first target UE and the second ToF information further includes a fourth time period between receiving the first SL-PRS by the second target UE and transmitting the third SL-PRS by the second target UE.

In some implementations, the third time period or the fourth time period is a particular value or preconfigured by a base station.

In some implementations, at least one of the first message or the second message includes a session identifier for identifying the single positioning session.

According to another innovative aspect of the present disclosure, a system for SL positioning of UEs in a single positioning session is disclosed. In one aspect, the system includes one or more processors; and one or more memory devices storing instructions that, when executed, cause the one or more processors to perform the operations including: transmitting, by a first UE, a first SL positioning reference signal (SL-PRS) to a second UE and a third UE; receiving, by the second UE and the third UE, the first SL-PRS; transmitting, by the second UE and in response to the received first SL-PRS, a second SL-PRS to the first UE; transmitting, by the third UE and in response to the received first SL-PRS, a third SL-PRS to the first UE; receiving, by the first UE, the second SL-PRS from the second UE and the third SL-PRS from the third UE; transmitting, by the first UE, a fourth SL-PRS to the second UE and the third UE; obtaining, by at least one of the first UE or the second UE, first time of flight (ToF) information indicative of a first distance between the first UE and the second UE based on at least one of the second SL-PRS or the fourth SL-PRS; and obtaining, by at least one of the first UE or the third UE, second ToF information indicative of a second distance between the first UE and the third UE based on at least one of the third SL-PRS or the fourth SL-PRS.

Other aspects include methods, apparatuses, and computer programs for performing the aforementioned operations.

The innovative system can include other optional features. For example, in some implementations, the operations can further include obtaining, by the first UE or the second UE, the first distance based on the first ToF information; and obtaining, by the first UE or the third UE, the second distance based on the second ToF information.

According to another innovative aspect of the present disclosure, one or more processors of a user equipment (UE) configured to perform operations for sidelink (SL) positioning of a plurality of UEs in a single positioning session are disclosed. In one aspect, the operations include receiving, by the UE, a first SL positioning reference signal (SL-PRS) from a first UE of the plurality of UEs; transmitting, by the UE and in response to the received first SL-PRS, a second SL-PRS to the first UE; receiving, by the UE and in response to transmitting the second SL-PRS, a third SL-PRS from the first UE; and obtaining, by the UE, time of flight (ToF) information indicative of a distance between the UE and the first UE based on at least one of the second SL-PRS or the third SL-PRS.

Other aspects include methods, apparatuses, systems, and computer programs for performing the aforementioned operations.

The innovative operations can include other optional features. For example, in some implementations, the operations can further include obtaining, by the UE, the distance between the UE and the first UE based on the ToF information.

### BRIEF DESCRIPTION OF THE DRAWINGS

FIG. 1 illustrates an example wireless network, in accordance with one aspect of the present disclosure.

FIG. 2 is a flowchart of an example process for SL positioning of multiple target UEs in a single positioning session executed by a reference UE, in accordance with one aspect of the present disclosure.

FIG. 3 is a diagram showing SL positioning of multiple target UEs based on an example single-sided Round-Trip Time (RTT) measurement, in accordance with one aspect of the present disclosure.

FIG. 4 is a flowchart of another example process for SL positioning of multiple target UEs in a single positioning session executed by a reference UE, in accordance with one aspect of the present disclosure.

FIG. 5 is a flowchart of an example process for SL positioning of multiple UEs in a single positioning session executed by at least three UEs, in accordance with one aspect of the present disclosure.

FIG. 6 is a diagram showing SL positioning of multiple target UEs based on an example double-sided Round-Trip Time (RTT) measurement, in accordance with one aspect of the present disclosure.

FIG. 7 is a block diagram of an example UE, in accordance with one aspect of the present disclosure.

FIG. 8 is a block diagram of an example access node, in accordance with one aspect of the present disclosure.

Like reference symbols in the various drawings indicate like elements.

### DETAILED DESCRIPTION

The existing wireless communication system may require multiple positioning sessions to perform sidelink (SL) positioning of multiple target UEs. Accordingly, this disclosure describes methods and systems for SL positioning of multiple target UEs in a single positioning session, allowing the generation and measurement of SL positioning reference signals for multiple target UEs at the same time. In these methods and systems, a single-sided RTT measurement or a double-sided RTT measurement can be used for SL positioning. In some implementations, SL positioning reference signals and the associated measurements are performed between one reference UE and multiple target UEs simultaneously in a single positioning session. The reference UE obtains absolute position, relative position, or ranging information of multiple target UEs over the SL interface. In some implementations, SL positioning reference signals and the associated measurements are performed between pairs of UEs separately in a single positioning session. Among other examples, the techniques of the disclosure can be used to determine a distance between a roadside unit, e.g., a traffic light (a reference UE), and multiple vehicles (multiple target UEs).

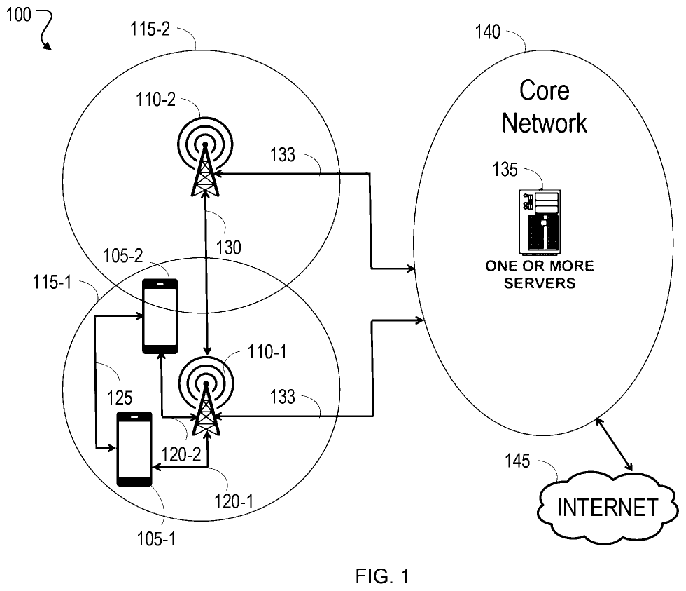

FIG. 1 illustrates an example communication system 100 that includes SL communications, in accordance with one aspect of the present disclosure. It is noted that the system of FIG. 1 is merely one example of a possible system, and that features of this disclosure may be implemented in other wireless communication systems.

The following description is provided for an example communication system that operates in conjunction with 5G networks as provided by 3GPP technical specifications. However, the example implementations are not limited in this regard, and the described examples may apply to other networks that may benefit from the principles described herein, such as 3GPP Long Term Evolution (LTE) networks, Wi-Fi or Worldwide Interoperability for Microwave Access (WiMax) networks, and the like. Furthermore, other types of communication standards are possible, including future 3GPP systems (e.g., Sixth Generation (6G)), IEEE 802.16 protocols, or the like. While aspects may be described herein using terminology commonly associated with 5G NR, aspects of the present disclosure can be applied to other systems, such as 3G, 4G, and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communication protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, an NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “preconfigured” with some parameters. In these examples, the parameters may be hardwired into the UEs 105 or coded into spec. Additionally and/or alternatively, the UEs 105 may receive the parameters from the one or more of the base stations 110.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2 X) specifications, or to one or more other or subsequent standards whereby vehicles and other devices and network entities may communicate. V2X communications may utilize both long-range (e.g., cellular) communications as well as short- to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and roadside units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (TX UE), and the UE receiving the communication is referred to as a receiver UE (RX UE). For example, UE 105-1 may be a TX UE, and UE 105-2 may be an RX UE. Although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

### Single-Sided RTT Measurement

RTT is a measure of the time it takes for a signal, such as a packet of data, to travel from a source to a destination and back again. RTT can be calculated by measuring the time between sending a packet from the source device to the destination device and receiving a response to the packet from the destination device to the source device.

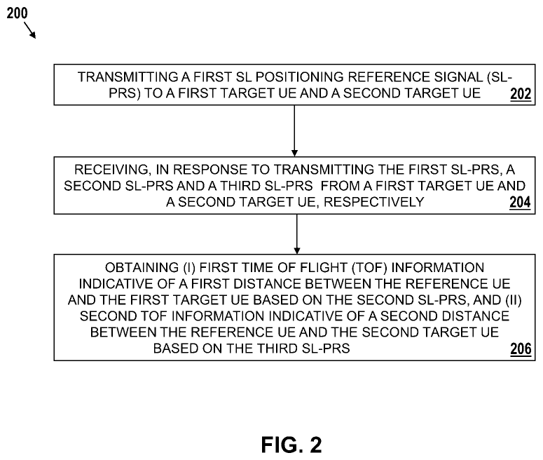

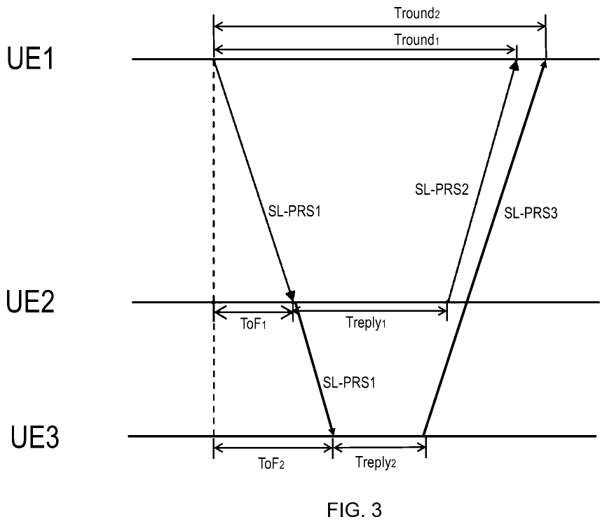

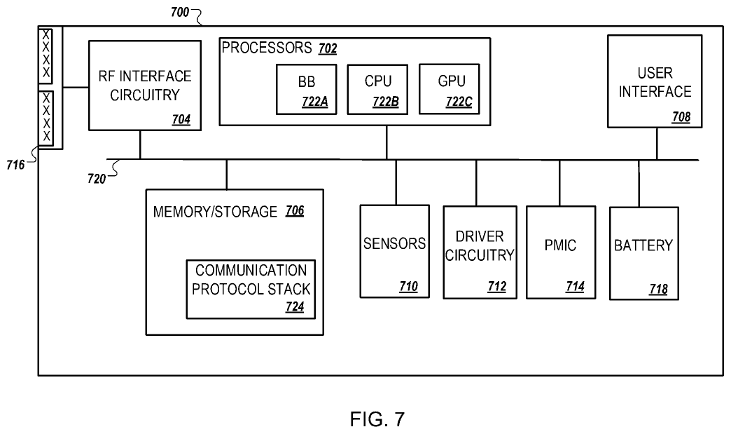

FIG. 2 is a flowchart of an example process for SL positioning of multiple target UEs in a single positioning session, in accordance with one aspect of the present disclosure. The process 200 is described as being performed by a reference UE such as UEs 105 of FIG. 1 or UE 700 of FIG. 7. FIG. 2 is described referring to FIG. 3, which is a diagram showing SL positioning of multiple target UEs based on an example single-sided Round-Trip Time (RTT) measurement, in accordance with one aspect of the present disclosure. The implementation of FIGS. 2 and 3 includes three UEs. A person having ordinary skills in the art can appreciate that the techniques of this disclosure also apply to more than three UEs. For example, an implementation can include one reference UE and more than two target UEs. In some implementations, the three UEs or more than three UEs can be a part of the same communication system (e.g., communication system 100 of FIG. 1).

A reference UE can begin execution of the process 200 at block 202. The reference UE transmits a first SL positioning reference signal (SL-PRS) to a first target UE and a second target UE. For example, referring to FIG. 3, reference UE1 transmits SL-PRS1 (the first SL-PRS) to target UE2 (the first target UE) and target UE3 (the second target UE).

At block 204, the reference UE receives, in response to transmitting the first SL-PRS, a second SL-PRS and a third SL-PRS from a first target UE and a second target UE, respectively. For example, referring to FIG. 3, in response to transmitting SL-PRS1, reference UE1 receives SL-PRS2 from target UE2 and SL-PRS3 from target UE3, respectively. At block 206, the reference UE obtains: (i) first time of flight (ToF) information indicative of a first distance between the reference UE and the first target UE based on the second SL-PRS, and (ii) second ToF information indicative of a second distance between the reference UE and the second target UE based on the third SL-PRS. For example, referring to FIG. 3, reference UE1 obtains ToF1 (the first ToF information) indicative of a first distance between the reference UE1 and target UE2, and ToF2 (the second ToF information) indicative of a second distance between the reference UE1 and target UE3.

In some implementations, instead of ToF1 and ToF2, the first ToF information includes a first time period (e.g., T_{round1}) between transmitting SL-PRS1 and receiving SL-PRS2. Similarly, the second ToF information includes a second time period (e.g., T_{round2}) between transmitting SL-PRS1 and receiving SL-PRS3. In some implementations, the first ToF information further includes a third time period (T_{reply1}) between receiving SL-PRS1 by the target UE2 and transmitting SL-PRS2 by the target UE2, and the second ToF information further includes a fourth time period (T_{reply2}) between receiving SL-PRS1 by the target UE3 and transmitting SL-PRS3 by the target UE3. T_{round1} and T_{reply1} can be used to calculate ToF1, and T_{round2} and T_{reply2} can be used to calculate ToF2.

The first distance between the reference UE1 and the target UE2 can be calculated based on the first ToF information by an LMF or an SL positioning server UE. Similarly, the second distance between the reference UE1 and the target UE3 can be calculated based on the second ToF information by an LMF. The SL positioning server UE performs SL-PRS configuration coordination and location calculation, and can be reference UE1, target UE2, or target UE3.

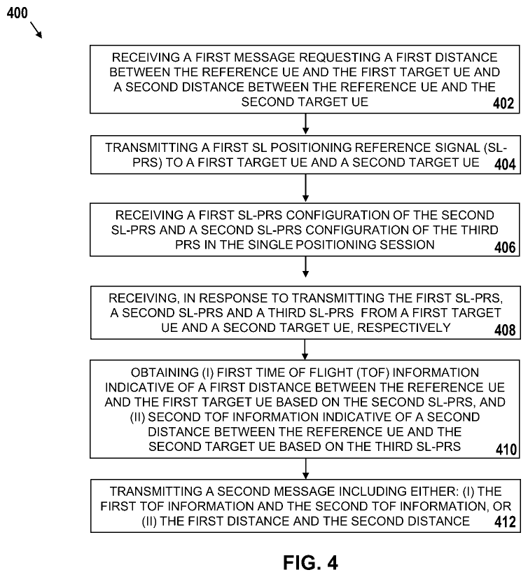

FIG. 4 is a flowchart of another example process 400 for SL positioning of multiple target UEs in a single positioning session, in accordance with one aspect of the present disclosure. The process 400 is described as being performed by a reference UE such as UEs 105 of FIG. 1 or UE 700 of FIG. 7. FIG. 4 is also described referring to FIG. 3. The implementation of FIG. 4 includes three UEs. A person having ordinary skills in the art can appreciate that the techniques of this disclosure also apply to more than three UEs. For example, an implementation can include one reference UE and more than two target UEs.

A reference UE can begin execution of the process 400 at block 402. The reference UE receives a first message requesting a first distance between the reference UE and the first target UE and a second distance between the reference UE and the second target UE. The first message includes information indicative of a positioning method (e.g., single-sided RTT technique or double-sided RTT technique [described in more detail below]), an identifier of the first target UE and an identifier of the second target UE. For example, referring to FIG. 3, the reference UE1 receives a first message requesting a first distance between the reference UE1 and the target UE2 and a second distance between the reference UE1 and the target UE3. The first message includes information indicative of a single-sided RTT technique, an identifier of the target UE2, and an identifier of the target UE3.

When in coverage, in some implementations, the LMF transmits the first message to the reference UE1 via LPP. When out of coverage, in some implementations, the target UE2 and/or the target UE3 transmits the first message to the reference UE1 via SLPP.

At block 404, the reference UE transmits a first SL positioning reference signal (SL-PRS) to a first target UE and a second target UE. For example, referring to FIG. 3, reference UE1 transmits SL-PRS1 (the first SL-PRS) to target UE2 (the first target UE) and target UE3 (the second target UE).

At block 406, the reference UE receives a first SL-PRS configuration of the second SL-PRS and a second SL-PRS configuration of the third SL-PRS in the single positioning session. For example, referring to FIG. 3, reference UE1 receives the first SL-PRS configuration of SL-PRS2 and the second SL-PRS configuration of SL-PRS3. Both target UE2 and target UE3 receive a third SL-PRS configuration of SL-PRS1. The SL-PRS configuration includes information that enables a UE to receive associated SL-PRS. For example, the first SL-PRS configuration enables reference UE1 to receive SL-PRS2, and the second SL-PRS configuration enables reference UE1 to receive SL-PRS3. The third SL-PRS configuration enables target UE2 and target UE3 to receive SL-PRS1. The information in the SL-PRS configuration includes at least the radio resources (or resource intervals) in which the measurement takes place. In some implementations, the information of the SL-PRS configuration can further include a session identifier for identifying the single positioning session.

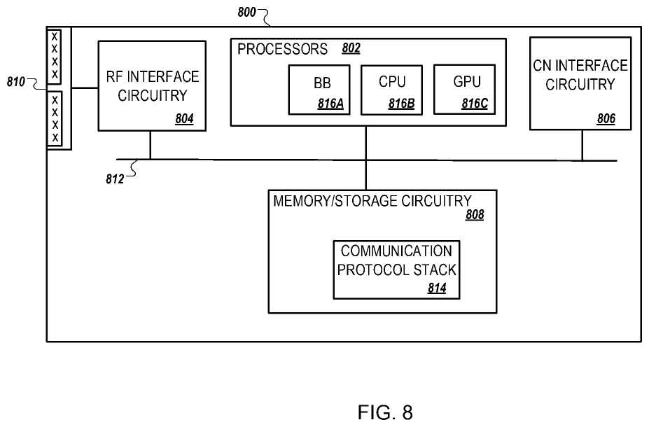

When in coverage, in some implementations, the base station (e.g., base stations 110 of FIG. 1 or access node 800 of FIG. 8) can provide SL-PRS configurations (e.g., the first SL-PRS configuration, the second SL-PRS configuration, the third SL-PRS configuration) via RRC signaling in the single positioning session.

When in coverage, in some implementations, the LMF can provide SL-PRS configurations (e.g., the first SL-PRS configuration, the second SL-PRS configuration, or the third SL-PRS configuration) via LPP in the single positioning session.

When out of coverage, in some implementations, an SL positioning server UE (reference UE1, target UE2, or target UE3) can provide SL-PRS configurations (e.g., the first SL-PRS configuration, the second SL-PRS configuration, the third SL-PRS configuration) via SLPP in the single positioning session. In particular, the SL positioning server UE broadcasts or groupcasts SL-PRS configurations to all the interested UEs. For example, the reference UE1, as an SL positioning server UE, can broadcast or groupcast SL-PRS configurations to target UE2 and target UE3. For another example, the target UE2, as an SL positioning server UE, can broadcast or groupcast SL-PRS configurations to reference UE 1 and target UE3.

In some implementations, if there is any collusion detected in the positioning session, the single positioning session would be discarded.

At block 408, the reference UE receives, in response to transmitting the first SL-PRS, a second SL-PRS and a third SL-PRS from a first target UE and a second target UE, respectively. For example, referring to FIG. 3, in response to transmitting SL-PRS1, reference UE1 receives SL-PRS2 from target UE2 and SL-PRS3 from target UE3, respectively.

At block 410, the reference UE obtains: (i) first time of flight (ToF) information indicative of a first distance between the reference UE and the first target UE based on the second SL-PRS, and (ii) second ToF information indicative of a second distance between the reference UE and the second target UE based on the third SL-PRS. For example, referring to FIG. 3, reference UE1 obtains the first ToF information indicative of a first distance between the reference UE1 and target UE2, and the second ToF information indicative of a second distance between the reference UE1 and target UE3.

At block 412, the reference UE transmits a second message including either: (i) the first ToF information and the second ToF information, or (ii) the first distance and the second distance. For example, referring to FIG. 3, reference UE1 transmits a second message including either: (i) the first ToF information and the second ToF information, or (ii) the first distance and the second distance. The first ToF information is indicative of the first distance between the reference UE1 and target UE2, and the second ToF information is indicative of the second distance between the reference UE1 and target UE3. When in coverage, the reference UE1 transmits the second message to the LMF via LPP. When out of coverage, the reference UE1 transmits the second message to the target UE2 and/or the target UE3 via SLPP.

In some implementations, the second message further includes at least one of RSRP, SL-PRS RSRPP, or SL-AoA for the first target UE (e.g., target UE2) or the second target UE (e.g., target UE3).

In some implementations, the first ToF information includes a first time period between transmitting the first SL-PRS and receiving the second SL-PRS, and the second ToF information includes a second time period between transmitting the first SL-PRS and receiving the third SL-PRS. For example, referring to FIG. 3, the first ToF information includes a first time period (e.g., T_{round1}) between transmitting SL-PRS1 and receiving SL-PRS2. The second ToF information includes a second time period (e.g., T_{round2}) between transmitting SL-PRS1 and receiving SL-PRS3.

In some implementations, the first ToF information further includes a third time period between receiving the first SL-PRS by the first target UE and transmitting the second SL-PRS by the first target UE. The second ToF information further includes a fourth time period between receiving the first SL-PRS by the second target UE and transmitting the third SL-PRS by the second target UE. For example, referring to FIG. 3, the first ToF information further includes a third time period (T_{reply1}) between receiving SL-PRS1 by the target UE2 and transmitting SL-PRS2 by the target UE2. The second ToF information further includes a fourth time period (T_{reply2}) between receiving SL-PRS1 by the target UE3 and transmitting SL-PRS3 by the target UE3. T_{round1} and T_{reply1} can be used to calculate ToF1, and T_{round2} and T_{reply2} can be used to calculate ToF2.

In some implementations, the third time period (e.g., T_{reply1}) or the fourth time period (e.g., T_{reply2}) is a particular value or preconfigured by a base station (e.g., base stations 110 of FIG. 1 or access node 800 of FIG. 8).

In some implementations, at least one of the first message or the second message includes a session identifier for identifying the single positioning session.

### Double-Sided RTT Measurement

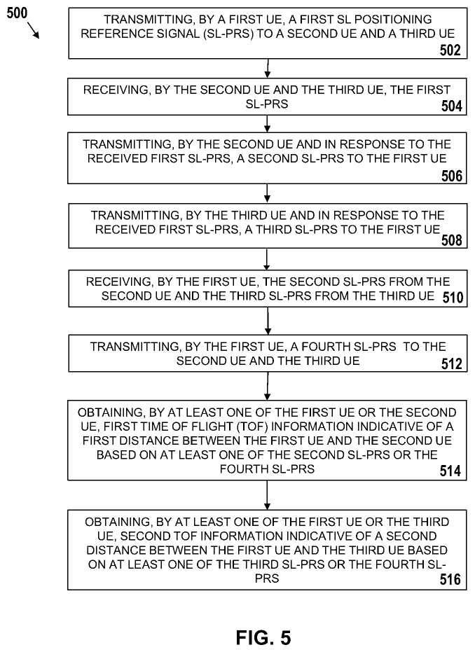

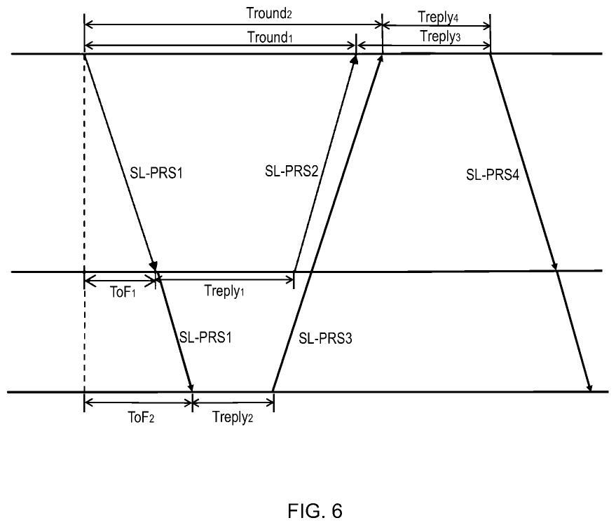

FIG. 5 is a flowchart of an example process for SL positioning of multiple UEs in a single positioning session executed by at least three UEs, in accordance with one aspect of the present disclosure. The process 500 is described as being performed by at least three UEs (UE1, UE2, and UE3, etc.), such as a UEs 105 of FIG. 1 or a UE 700 of FIG. 7. The process 500 is described referring to FIG. 6, which is a diagram showing SL positioning of multiple target UEs based on an example double-sided Round-Trip Time (RTT) measurement, in accordance with one aspect of the present disclosure. The implementation of FIGS. 5 and 6 includes three UEs. A person having ordinary skills in the art can appreciate that the techniques of this disclosure also apply to more than three UEs. For example, an implementation can include one reference UE and more than two target UEs. In some implementations, the three UEs or more than three UEs can be a part of the same communication system (e.g., communication system 100 of FIG. 1).

A first UE can begin execution of the process 500 at block 502. The first UE transmits a first SL SL-PRS to a second UE and a third UE. For example, referring to FIG. 6, UE1 transmits SL-PRS1 to UE2 and UE3.

At block 504, The second UE and the third UE receive the first SL-PRS. For example, referring to FIG. 6, UE2 and UE3 receive SL-PRS1 from UE1.

At block 506, the second UE transmits, in response to the received first SL-PRS, a second SL-PRS to the first UE. For example, referring to FIG. 6, in response to the received SL-PRS1, UE2 transmits SL-PRS2 to UE1.

At block 508, the third UE transmits, in response to the received first SL-PRS, a third SL-PRS to the first UE. For example, referring to FIG. 6, in response to the received SL-PRS1, UE3 transmits SL-PRS3 to UE1.

At block 510, The first UE receives the second SL-PRS from the second UE and the third SL-PRS from the third UE. For example, referring to FIG. 6, UE1 receives SL-PRS2 from UE2 and SL-PRS3 from UE3.

At block 512, the first UE transmits a fourth SL-PRS to the second UE and the third UE. For example, referring to FIG. 6, UE1 transmits SL-PRS4 to UE2 and UE3. Compared to FIG. 3, the difference between FIG. 6 and FIG. 3 is that UE1 transmits SL-PRS4 to UE2 and UE3, in response to SL-PRS2 from UE2 and SL-PRS3 from UE3, respectively. The time period between receiving SL-PRS2 by UE1 and transmitting SL-PRS4 by UE1 is T_{reply3}. The time period between receiving SL-PRS3 by UE1 and transmitting SL-PRS4 by UE1 is T_{reply4}. Similarly to FIG. 3, in FIG. 6, UE1 can be a reference UE, and UE2 and UE3 are target UEs. Unlike FIG. 3, in FIG. 6, UE2 can be a reference UE, and UE1 is a target UE. UE3 can also be a reference UE, and UE1 is a target UE.

At block 514, at least one of the first UE or the second obtains first ToF information indicative of a first distance between the first UE and the second UE based on at least one of the second SL-PRS or the fourth SL-PRS. For example, referring to FIG. 6, UE1 and/or UE2 obtain first ToF information indicative of a first distance between UE1 and UE2 based on SL-PRS2 and/or SL-PRS4.

At block 516, at least one of the first UE or the third UE obtains second ToF information indicative of a second distance between the first UE and the third UE based on at least one of the third SL-PRS or the fourth SL-PRS. For example, referring to FIG. 6, UE1 and/or UE3 obtain second ToF information indicative of a second distance between UE1 and UE3 based on SL-PRS3 and/or SL-PRS4.

In some implementations, UE1 or UE2 obtains the first distance based on the first ToF information, and UE1 or UE3 obtains the second distance based on the second ToF information. The first distance between UE1 and UE2 can be calculated based on the first ToF information by an LMF or an SL positioning server UE, which can be any UE, such as UE1, UE2, or UE3. Similarly, the second distance between UE1 and UE3 can be calculated based on the second ToF information by an LMF.

In some implementations, an example process for SL positioning of multiple UEs (e.g., including UE1) in a single positioning session is provided. The example process is executed by UE2 or UE3. UE2 or UE3 receives SL-PRS1 from UE1. UE2 or UE3 transmits SL-PRS2 to the UE1, in response to the received SL-PRS1. UE2 or UE3 receives SL-PRS3 from UE1, in response to transmitting SL-PRS2. UE2 or UE3 obtains ToF information indicative of a distance between UE1 and UE2 or UE3 based on SL-PRS2 and/or SL-PRS3. UE2 or UE3 obtains the distance between UE1 and UE2 or UE3 based on the ToF information.

FIG. 7 is a block diagram of an example UE, in accordance with one aspect of the present disclosure. The UE 700 may be similar to and substantially interchangeable with UEs 105 of FIG. 1.

The UE 700 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, antenna structure 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 includes any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716.

In various implementations, the RF interface circuitry 704 may be configured to transmit/receive signals in a manner compatible with NR access technologies.

The antenna 716 may include antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FRI or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in their environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensor circuitry 728 and control and allow access to sensor circuitry 728, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700 including DRX as discussed herein. A battery 718 may power the UE 700, although in some examples the UE 700 may be mounted or deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

FIG. 8 is a block diagram of an example access node, in accordance with one aspect of the present disclosure. FIG. 8 illustrates an access node 800 (e.g., a base station or gNB), in accordance with some implementations. The access node 800 may be similar to and substantially interchangeable with the base stations 110 of FIG. 1. The access node 800 may include processors 802, RF interface circuitry 804, core network (CN) interface circuitry 806, memory/storage circuitry 808, and antenna structure 810.

The components of the access node 800 may be coupled with various other components over one or more interconnects 812. The processors 802, RF interface circuitry 804, memory/storage circuitry 808 (including communication protocol stack 814), antenna structure 810, and interconnects 812 may be similar to like-named elements shown and described with respect to FIG. 7. For example, the processors 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5^{th} Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 800; a MAC/PHY split wherein RRC, PDCP, RLC, and MAC layers are operated by the CRAN/vBBUP and the PHY layer is operated by the access node 800; or a “lower PHY” split wherein RRC, PDCP, RLC, MAC layers and upper portions of the PHY layer are operated by the CRAN/VBBUP and lower portions of the PHY layer are operated by the access node 800.

In V2X scenarios, the access node 800 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors of a reference user equipment (UE) configured to, when executing instructions stored in a memory, perform operations for sidelink (SL) positioning of target UEs in a single positioning session, the operations comprising:
transmitting, by the reference UE, a first SL positioning reference signal (SL-PRS) to a first target UE and a second target UE;
receiving, by the reference UE and in response to transmitting the first SL-PRS, a second SL-PRS and a third SL-PRS from the first target UE and the second target UE, respectively; and
obtaining, by the reference UE, (i) first time of flight (ToF) information indicative of a first distance between the reference UE and the first target UE based on the second SL-PRS, and (ii) second ToF information indicative of a second distance between the reference UE and the second target UE based on the third SL-PRS.

2. The one or more processors of claim 1, the operations further comprising:
transmitting, by the reference UE, a fourth SL-PRS to the first target UE and the second target UE in response to receiving the second SL-PRS and the third SL-PRS, wherein the first target UE and the second target UE use the fourth SL-PRS to calculate respective ToF information indicative of a distance between the respective target UE and the reference UE.

3. The one or more processors of claim 1, the operations further comprising:
obtaining, by the reference UE, the first distance based on the first ToF information and the second distance based on the second ToF information.

4. The one or more processors of claim 1, the operations further comprising:
receiving, by the reference UE and from a base station, a first SL-PRS configuration of the second SL-PRS and a second SL-PRS configuration of the third SL-PRS, via radio resource control (RRC) signaling in the single positioning session.

5. The one or more processors of claim 1, the operations further comprising:
receiving, by the reference UE and from a location measurement function (LMF), a first SL-PRS configuration of the second SL-PRS and a second SL-PRS configuration of the third SL-PRS, via LTE Positioning Protocol (LPP) signaling in the single positioning session.

6. The one or more processors of claim 1, the operations further comprising:
receiving, by the reference UE and from the first target UE, a first SL-PRS configuration of the second SL-PRS and a second SL-PRS configuration of the third SL-PRS, via a Sidelink Positioning Protocol (SLPP) in the single positioning session.

7. The one or more processors of claim 4, wherein at least one of the first SL-PRS configuration or the second SL-PRS configuration comprises a session identifier for identifying the single positioning session.

8. The one or more processors of claim 1, the operations further comprising:
receiving, by the reference UE and from a location measurement function (LMF) via LTE Positioning Protocol (LPP), a first message requesting the first distance between the reference UE and the first target UE and the second distance between the reference UE and the second target UE, wherein the first message includes an identifier of the first target UE and an identifier of the second target UE; and
transmitting, by the reference UE and to the LMF, a second message comprising either: (i) the first ToF information and the second ToF information, or (ii) the first distance and the second distance.

9. The one or more processors of claim 8, wherein the second message further comprises at least one of Sidelink Positioning Reference Signal Received Power (RSRP), Sidelink Positioning Reference Signal Received Power per resource element (SL-PRS RSRPP), or Sidelink Angle of Arrival (SL-AoA).

10. The one or more processors of claim 8, wherein the first ToF information comprises a first time period between transmitting the first SL-PRS and receiving the second SL-PRS, and the second ToF information comprises a second time period between transmitting the first SL-PRS and receiving the third SL-PRS.

11. The one or more processors of claim 10, wherein the first ToF information further comprises a third time period between receiving the first SL-PRS by the first target UE and transmitting the second SL-PRS by the first target UE, and the second ToF information further comprises a fourth time period between receiving the first SL-PRS by the second target UE and transmitting the third SL-PRS by the second target UE, wherein the third time period or the fourth time period is a predetermined value or preconfigured by a base station.

12. (canceled)

13. The one or more processors of claim 8, wherein at least one of the first message or the second message comprises a session identifier for identifying the single positioning session.

14. The one or more processors of claim 1, the operations further comprising:
receiving, by the reference UE and from the first target UE and the second target UE, via Sidelink Positioning Protocol (SLPP), a first message requesting the first distance between the reference UE and the first target UE and the second distance between the reference UE and the second target UE, wherein the first message includes an identifier of the first target UE and an identifier of the second target UE; and
transmitting, by the reference UE and to the first target UE and the second target UE, a second message comprising either: (i) the first ToF information and the second ToF information, or (ii) the first distance and the second distance.

15. The one or more processors of claim 14, wherein the second message further comprises at least one of Sidelink Positioning Reference Signal Received Power (RSRP), Sidelink Positioning Reference Signal Received Power per resource element (SL-PRS RSRPP), or Sidelink Angle of Arrival (SL-AoA) for the first target UE or the second target UE.

16. The one or more processors of claim 14, wherein the first ToF information comprises a first time period between transmitting the first SL-PRS and receiving the second SL-PRS, and the second ToF information comprises a second time period between transmitting the first SL-PRS and receiving the third SL-PRS.

17. The one or more processors of claim 16, wherein the first ToF information further comprises a third time period between receiving the first SL-PRS by the first target UE and transmitting the second SL-PRS by the first target UE and the second ToF information further comprises a fourth time period between receiving the first SL-PRS by the second target UE and transmitting the third SL-PRS by the second target UE, wherein the third time period or the fourth time period is a particular value or preconfigured by a base station.

18. (canceled)

19. The one or more processors of claim 14, wherein at least one of the first message or the second message comprises a session identifier for identifying the single positioning session.

20. A method of performing operations, comprising:
transmitting, by a reference UE, a first SL positioning reference signal (SL-PRS) to a first target UE and a second target UE;
receiving, by the reference UE and in response to transmitting the first SL-PRS, a second SL-PRS and a third SL-PRS from the first target UE and the second target UE, respectively; and
obtaining, by the reference UE, (i) first time of flight (ToF) information indicative of a first distance between the reference UE and the first target UE based on the second SL-PRS, and (ii) second ToF information indicative of a second distance between the reference UE and the second target UE based on the third SL-PRS.

21. (canceled)

22. One or more processors of a user equipment (UE) configured to, when executing instructions stored in a memory, perform operations for sidelink (SL) positioning of a plurality of UEs in a single positioning session, the operations comprising:
receiving, by the UE, a first SL positioning reference signal (SL-PRS) from a first UE of the plurality of UEs;
transmitting, by the UE and in response to the received first SL-PRS, a second SL-PRS to the first UE;
receiving, by the UE and in response to transmitting the second SL-PRS, a third SL-PRS from the first UE; and
obtaining, by the UE, time of flight (ToF) information indicative of a distance between the UE and the first UE based on at least one of the second SL-PRS or the third SL-PRS.

23. The one or more processors of claim 22, the operations further comprising:
obtaining, by the UE, the distance between the UE and the first UE based on the ToF information.
